(19) United States
(12) Patent Application Publication
(10) Pub. No.: US 2018/0347616 A1
(43) Pub. Date: Dec. 6, 2018

(54) LINEARIZED JOINT INTERFACE

(71) Applicants: Christoph Schwingshackl, London (GB); National Technology & Engineering Solutions of Sandia, LLC, Albuquerque, NM (US)

(72) Inventors: Matthew Robert Brake, Pearland, TX (US); Christoph Schwingshackl, London (GB)

(21) Appl. No.: 15/612,888

(22) Filed: Jun. 2, 2017

(51) Int. Cl. F16B 37/08; F16B 5/00

(52) U.S. Cl. CPC F16B 37/085; F16B 5/0004

(57) ABSTRACT

A method for joining two or more joined parts and a linearized joint interface are provided. The linearized joint interface comprises a first structure having a first bolt hole extending through a first contact surface. The first contact surface comprises at least one integral contact pad protruding from the first contact surface. The linearized joint interface further comprises second structure having a second bolt hole extending through a second contact surface. The first contact surface and the second contact surface overlap to form the linearized joint interface. A bolt is positioned through the first bolt hole and the second bolt hole. An applied load is applied at the bolt to compress the linearized joint interface. Contact between the first contact surface and the second contact surface is effectively limited to the contact pad.

This invention was made with United States Government support under Contract No. DE-NA0003525 between National Technology & Engineering Solutions of Sandia, LLC and the United States Department of Energy. The United States Government has certain rights in this invention.

### BACKGROUND INFORMATION

### 1. Field

The present disclosure relates generally to an improved mechanical joint between two or more joined parts and, in particular, to a method and a mechanical joint for joining two or more joined parts. Still more particularly, the present disclosure relates to a method for joining two or more joined parts and a mechanical joint having dynamic properties that are independent of response amplitude.

### 2. Background

With the recent investment in additive manufacturing and topology optimization, parts are fabricated that have optimal vibration and structural dynamic behavior. The attractiveness of additive manufacturing is that it is possible to create monolithic structures that do not necessitate interfaces. Vibrations and structural dynamics of single parts, i.e. monolithic specimens, can be accurately predicted on their own with no regard for their behavior in a jointed assembly.

However, these monolithic structures typically have very poor dynamic properties due to insufficient energy dissipation. For example, systems that have been redesigned to minimize the number of structural joints may fail in common operating environments due to a lack of damping in the system that resulted in vibrational instabilities. Thus, the damping provided by interfaces is still necessary for sufficient energy dissipation from the structure.

Mechanical joints therefore remain common in most assembled structures. Mechanical joints are typically the greatest source of structural dynamic uncertainty and variability in a structure. However, there are no accurate models to predict the structural dynamics of the larger systems once the individual parts are assembled. Further complicating matters, physical processes in the joint are not well understood. As defined herein, mechanical joints are the joining of two bodies via contact at a shared interface.

Prediction of interfacial dissipation and stiffness of a joint is paramount for designing a structure. However, the lack of understanding of joint dynamics and physical processes often results in high variability and non-repeatability observed in experiments of the same structure. For example, observed stiffness variations of 25%, and observed damping variations of 300% are not uncommon, resulting in predictions of energy dissipation often off by orders of magnitude. Not only are the predictions often off by an order of magnitude, but the uncertainty associated with a jointed structure is often prohibitively large for deterministic modeling. Therefore, this uncertainty often necessitates multiple expensive experiments to predict dynamic properties of the assembled system.

An ideal interface in these systems is one that is predictable and that affords a high amount of damping to the system. If a strategy existed to design a system instead of individual parts, then the uncertainty associated with the loads being transmitted across interfaces could be reduced, therefore improving the ability to design jointed systems for specific environments.

Therefore, it would be desirable to have a method and apparatus that take into account at least some of the issues discussed above, as well as other possible issues. For example, it would be desirable to have a method for joining two or more joined parts and a mechanical joint having dynamic properties that are independent of response amplitude.

### SUMMARY

In one illustrative example, a linearized joint interface is provided. The linearized joint interface comprises a first structure having a first bolt hole extending through a first contact surface. The first contact surface comprises at least one integral contact pad protruding from the first contact surface. The linearized joint interface further comprises second structure having a second bolt hole extending through a second contact surface. The first contact surface and the second contact surface overlap to form the linearized joint interface. A bolt is positioned through the first bolt hole and the second bolt hole. An applied load is applied at the bolt to compress the linearized joint interface. Contact between the first contact surface and the second contact surface is effectively limited to the contact pad.

In another illustrative example, a method of joining structures along a linearized joint interface is provided. The method comprises providing a first structure having a first bolt hole extending through a first contact surface. The first contact surface comprises at least one integral contact pad protruding from the first contact surface. The method further comprises providing a second structure having a second bolt hole extending through a second contact surface. The first contact surface and the second contact surface overlap to form the linearized joint interface. The method further comprises positioning a bolt through the first bolt hole and the second bolt hole. The method further comprises applying a load at the bolt to compress the linearized joint interface. Contact between the first contact surface and the second contact surface is effectively limited to the contact pad.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a joint interface, depicted according to the prior art;

FIG. 2 is a linearized joint interface depicted according to a first illustrative embodiment;

FIG. 3 is an exploded linearized joint interface depicted according to the first illustrative embodiment;

FIG. 4 is a linearized joint interface including a plurality of integral contact pads depicted according to the first illustrative embodiment;

FIG. 5 is a linearized joint interface depicted according to a second illustrative embodiment;

FIG. 6 is an exploded linearized joint interface depicted according to the second illustrative embodiment;

FIG. 7 is a linearized joint interface including a plurality of integral contact pads depicted according to the second illustrative embodiment;

FIG. 8 is a flowchart of a process for joining structures along a linearized joint interface depicted according to an illustrative embodiment;

FIGS. 9A-9D are schematics for a baseline joint interface configuration, depicted according to illustrative embodiments;

FIGS. 10A-10D are dynamic responses of baseline joint interface configuration 900 of FIG. 9A-9D, depicted according to illustrative embodiments;

FIGS. 11A-11D are schematics for a linearized joint interface configuration, depicted according to illustrative embodiments; and

FIGS. 12A-12D are dynamic responses of linearized joint interface configuration 1100 of FIG. 11A-11D, depicted according to illustrative embodiments.

### DETAILED DESCRIPTION

The illustrative embodiments recognize and take into account one or more different considerations. For example, the illustrative embodiments recognize and take into account that it would be desirable to have a method for joining two or more joined parts and a mechanical joint having dynamic properties that are independent of response amplitude. The illustrative embodiments also recognize and take into account that designing jointed systems for specific environments may be more difficult than desired due to the uncertainty associated with the loads being transmitted across jointed interfaces.

In order to overcome at least some of these issues, the illustrative embodiments provide a linearized joint interface for joining two or more joined parts. By linearized, this refers specifically to the dynamic properties being independent of response amplitude, which is common amongst mechanical joints and presents a significant design and analysis challenge.

Dynamic properties of jointed systems that include the linearized joint interface are more linear than jointed systems that do not include the linearized joint interface. Dynamic properties of jointed systems that include the linearized joint interface are independent of response amplitude and more predictable than jointed systems that do not include the linearized joint interface. Correspondingly, the linearized joint interface provides dynamic properties that are more repeatable and more predictable compared to previously known joint interfaces.

Thus, the illustrative embodiments provide a method for joining two or more joined parts and a linearized joint interface having dynamic properties that are independent of response amplitude. In one illustrative example, a linearized joint interface comprises a first structure having a first bolt hole extending through a first contact surface. The first contact surface comprises at least one integral contact pad protruding from the first contact surface. The linearized joint interface further comprises a second structure having a second bolt hole extending through a second contact surface. The first contact surface and the second contact surface overlap to form the linearized joint interface. A bolt is positioned through the first bolt hole and the second bolt hole. An applied load is applied at the bolt to compress the linearized joint interface. Contact between the first contact surface and the second contact surface is effectively limited to the contact pad.

With reference now to the figures and, in particular, with reference to FIG. 1, a joint interface is illustrated according to the prior art. As depicted, joint interface 100 includes first structure 102 and second structure 104.

First structure 102 and second structure 104 are examples of structures that can be joined at joint interface 100. First structure 102 includes first bolt hole 106 and first contact surface 108. First bolt hole 106 extends through first contact surface 108.

Second structure 104 includes second bolt hole 110 and second contact surface 112. Second bolt hole 110 extends through second contact surface 112. First contact surface 108 and second contact surface 112 overlap to form joint interface 100.

Bolt 114 is positioned through first bolt hole 106 and second bolt hole 110. Applied load 116 is applied at bolt 114 to compress joint interface 100. Joint interface 100 illustrates a form of complete contact between first contact surface 108 and second contact surface 112.

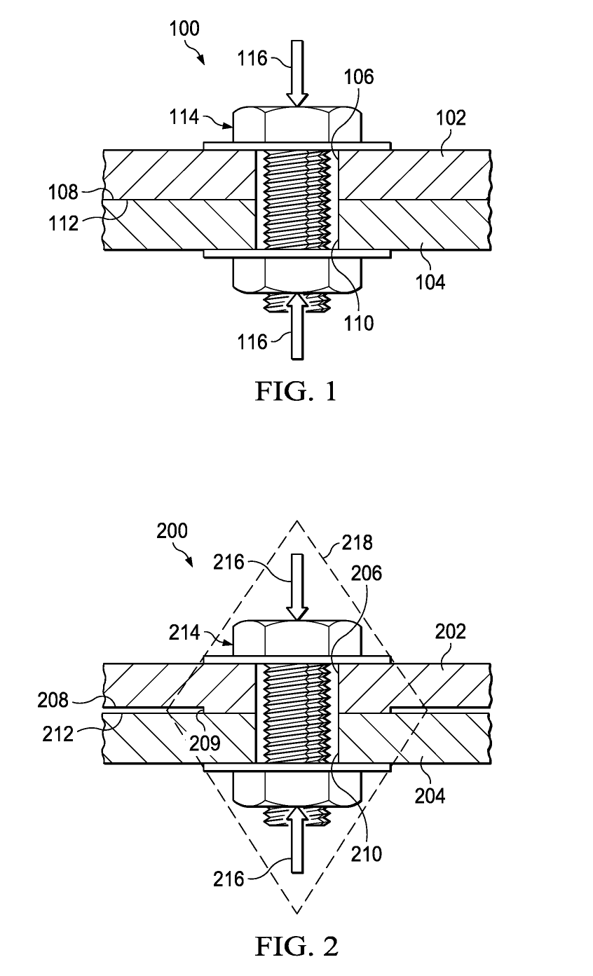

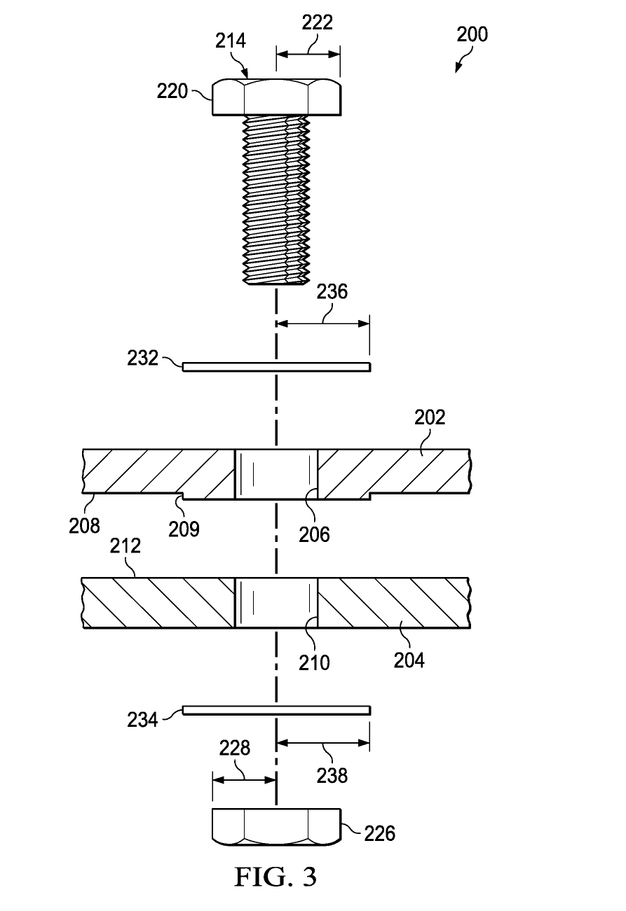

With reference now to FIGS. 2-3, a linearized joint interface is depicted according to a first illustrative embodiment. As depicted, linearized joint interface 200 includes first structure 202 and second structure 204.

First structure 202 includes first bolt hole 206, first contact surface 208, and at least one of contact pad 209. First bolt hole 206 extends through first contact surface 208. Contact pad 209 is integral with first contact surface 208. Contact pad 209 protrudes from first contact surface 208.

Second structure 204 can be a structure such as second structure 104 of FIG. 1. Second structure 204 includes second bolt hole 210 and second contact surface 212. Second bolt hole 210 extends through second contact surface 212. First contact surface 208 and second contact surface 212 overlap to form linearized joint interface 200.

Bolt 214 is positioned through first bolt hole 206 and second bolt hole 210. Applied load 216 is applied at bolt 214 to compress linearized joint interface 200. In linearized joint interface 200, contact between first contact surface 208 and second contact surface 212 is effectively limited to contact pad 209.

In this illustrative example, contact pad 209 is circumferentially arranged around first bolt hole 206. Contact between first contact surface 208 and second contact surface 212 at contact pad 209 effectively occurs only under applied load 216 within pressure cone 218 of bolt 214.

Linearized joint interface 200 redesigns the contact geometry of traditional joint interfaces, such as joint interface 100 shown in FIG. 1. Linearized joint interface 200 minimizes relative motion between first contact surface 208 and second contact surface 212 for applied load 216 that is below a macroslip threshold. The macroslip threshold is defined to be the load at which two bodies that are joined together move relative to one another.

Contact pressure is highest between first contact surface 208 and second contact surface 212 directly under applied load 216. Because linearized joint interface 200 limits contact to contact pad 209 within pressure cone 218, a higher load is required to initiate microslip between first contact surface 208 and second contact surface 212. Microslip between first contact surface 208 and second contact surface 212 is the relative motion of a portion of linearized joint interface 200 that is achieved before macroslip between first contact surface 208 and second contact surface 212.

Referring now to FIG. 3, in an illustrative example, bolt 214 comprises bolt head 220 having bolt head radius 222. Linearized joint interface 200 further includes nut 226 having nut radius 228. Nut 226 secures bolt 214 within first bolt hole 206 and second bolt hole 210. In this illustrative example, applied load 216 is applied at bolt 214 by torqueing nut 226 around bolt 214.

Continuing with the current illustrative example, pad radius 230 of contact pad 209 is less than one or more of bolt head radius 222 and nut radius 228. When pad radius 230 of contact pad 209 is less than one or more of bolt head radius 222 and nut radius 228, contact between first contact surface 208 and second contact surface 212 is within pressure cone 218. Because linearized joint interface 200 limits contact to contact pad 209 within pressure cone 218, a higher load is required to initiate microslip between first contact surface 208 and second contact surface 212, the relative motion of a portion of the interface that is achieved before macroslip between first contact surface 208 and second contact surface 212.

In an illustrative example, linearized joint interface 200 can further include one or more of first washer 232 and second washer 234. As depicted, first washer 232 has first washer radius 236 and is positioned between bolt head 220 and a non-contact surface of first structure 202. As depicted, second washer 234 has second washer radius 238 and is positioned between nut 226 and a non-contact surface of second structure 204.

Continuing with the current illustrative example, pad radius 230 of contact pad 209 is less one or more of first washer radius 236 and second washer radius 238. When pad radius 230 of contact pad 209 is less one or more of first washer radius 236 and second washer radius 238, contact between first contact surface 208 and second contact surface 212 is within pressure cone 218. Because linearized joint interface 200 limits contact to contact pad 209 within pressure cone 218, a higher load is required to initiate microslip between first contact surface 208 and second contact surface 212. Microslip between first contact surface 208 and second contact surface 212 is the relative motion of a portion of linearized joint interface 200 that is achieved before macroslip between first contact surface 208 and second contact surface 212.

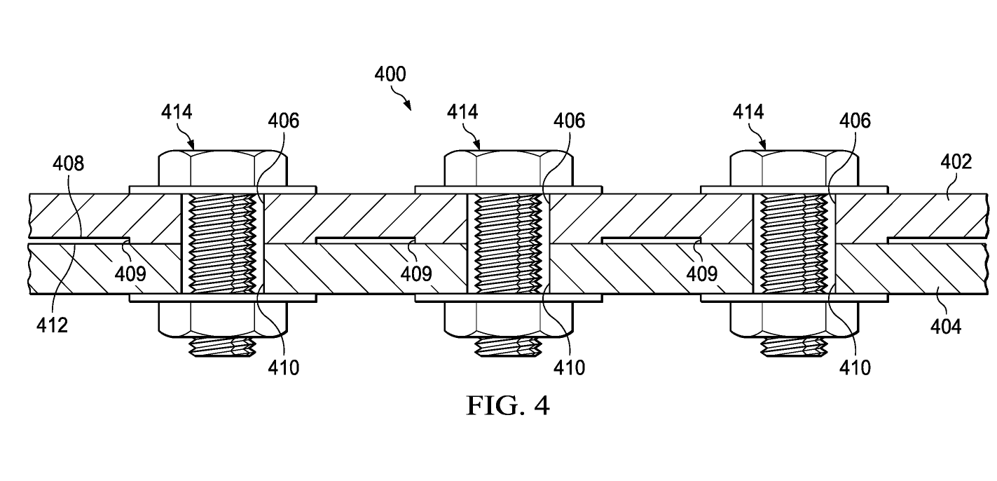

With reference now to FIG. 4, a linearized joint interface including a plurality of integral contact pads is depicted according to the first illustrative embodiment. In this illustrative example, linearized joint interface 400 includes first structure 402 and second structure 404.

First structure 402 is a structure such as first structure 202 of FIG. 2. First structure 402 includes first plurality of bolt holes 406, first contact surface 408, and plurality of integral contact pads 409. First plurality of bolt holes 406 extends through first contact surface 408. Plurality of integral contact pads 409 is integral with first contact surface 408. Plurality of integral contact pads 409 protrudes from first contact surface 408.

Second structure 404 is a structure such as second structure 204 of FIG. 2. Second structure 404 includes second plurality of bolt holes 410 and second contact surface 412. Second plurality of bolt holes 410 extends through second contact surface 412. First contact surface 408 and second contact surface 412 overlap to form linearized joint interface 400.

Respective ones of plurality of bolts 414 are positioned through respective ones of first plurality of bolt holes 406 and second plurality of bolt holes 410. Applied load 416 is applied at plurality of bolts 414 to compress linearized joint interface 400. In linearized joint interface 400, contact between first contact surface 408 and second contact surface 412 is effectively limited to plurality of integral contact pads 409.

In this illustrative example, each of plurality of integral contact pads 409 is circumferentially arranged around a respective one of first plurality of bolt holes 406. Contact between first contact surface 408 and second contact surface 412 at plurality of integral contact pads 409 effectively occurs only under applied load 416 within pressure cones 418 of plurality of bolts 414.

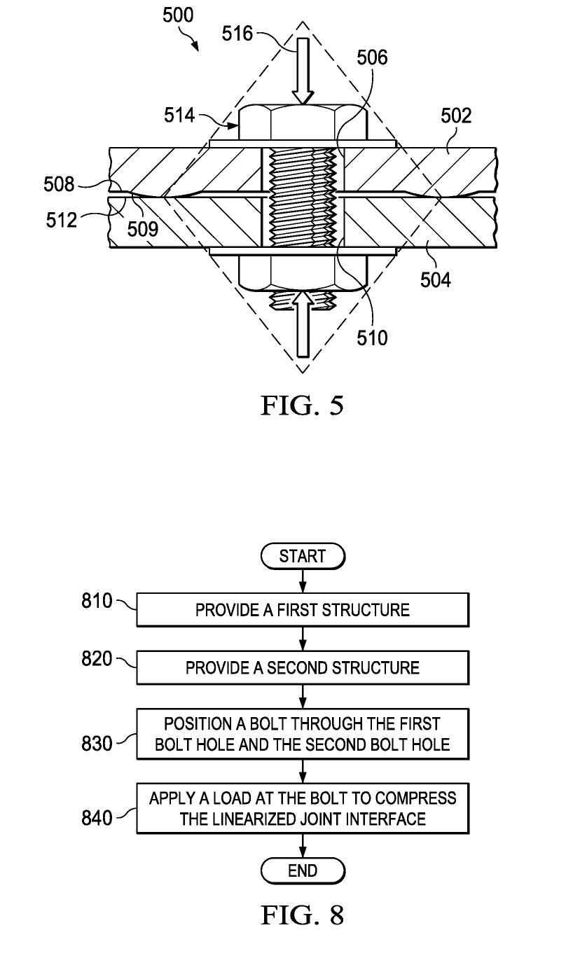

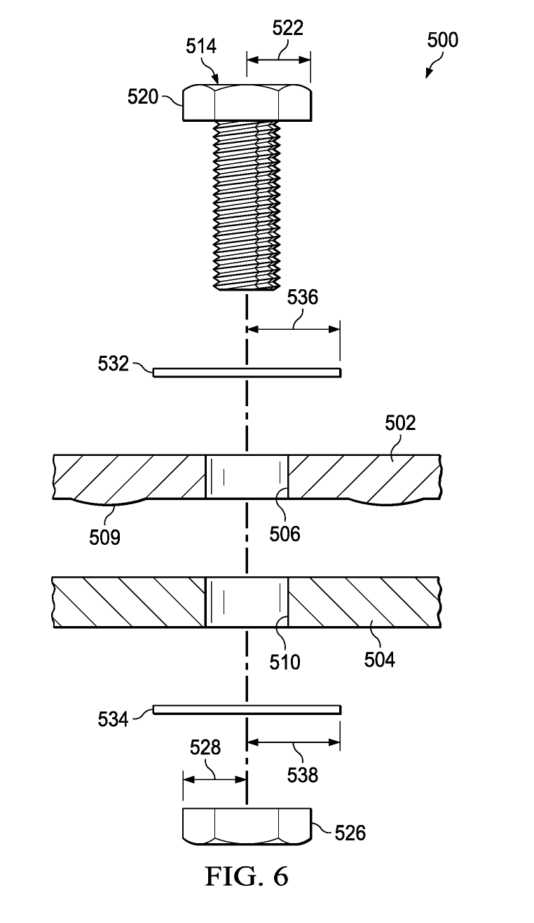

With reference now to FIGS. 5-6, a linearized joint interface is depicted according to a second illustrative embodiment. Linearized joint interface 500 includes first structure 502 and second structure 504.

First structure 502 is a structure such as first structure 202 of FIG. 2. First structure 502 includes first bolt hole 506, first contact surface 508, and at least one of contact pad 509. First bolt hole 506 extends through first contact surface 508. Contact pad 509 is integral with first contact surface 508. Contact pad 509 protrudes from first contact surface 508.

Second structure 504 is a structure such as structure 304 of FIG. 3. Second structure 504 includes second bolt hole 510 and second contact surface 512. Second bolt hole 510 extends through second contact surface 512. First contact surface 508 and second contact surface 512 overlap to form linearized joint interface 500.

Bolt 514 is positioned through first bolt hole 506 and second bolt hole 510. Applied load 516 is applied at bolt 514 to compress linearized joint interface 500. In linearized joint interface 500, contact between first contact surface 508 and second contact surface 512 is effectively limited to contact pad 509.

In this illustrative example, contact pad 509 is sequentially arranged with first bolt hole 506. In this illustrative example, contact pad 509 takes the form of a right circular cylindrical segment protruding from first contact surface 508. Contact pad 509 of first contact surface 508 is in Hertzian contact with second contact surface 512.

Linearized joint interface 500 redesigns the contact geometry of traditional joint interfaces, such as joint interface 100 shown in FIG. 1. Linearized joint interface 500 minimizes relative motion between first contact surface 508 and second contact surface 512 of linearized joint interface 500 for applied load 516 that is below the macroslip threshold.

For incomplete contact, such as Hertzian contact, the contact area is a function of the applied normal load, and the contact pressure smoothly tends to zero as the contact edge is approached. Because linearized joint interface 500 limits contact to Hertzian contact at contact pad 509, a higher load is required to initiate microslip between first contact surface 508 and second contact surface 512, the relative motion of a portion of the interface that is achieved before macroslip between first contact surface 508 and second contact surface 512.

Referring now to FIG. 6, in this illustrative example, bolt 514 comprises bolt head 520 having bolt head radius 522. Linearized joint interface 500 further includes nut 526 having nut radius 528. Nut 526 secures bolt 514 within first bolt hole 506 and second bolt hole 510. In this illustrative example, applied load 516 is applied at bolt 514 by torqueing nut 526 around bolt 514.

Linearized joint interface 500 can further include one or more of first washer 532 and second washer 534. As depicted, first washer 532 has first washer radius 536 and is positioned between bolt head 520 and a non-contact surface of first structure 502. As depicted, second washer 534 has second washer radius 538 and is positioned between nut 526 and a non-contact surface of second structure 504. In this illustrative example, contact between first contact surface 508 and second contact surface 512 at the contact pad 509 does not necessarily occur under applied load 516 within a pressure cone around bolt 514.

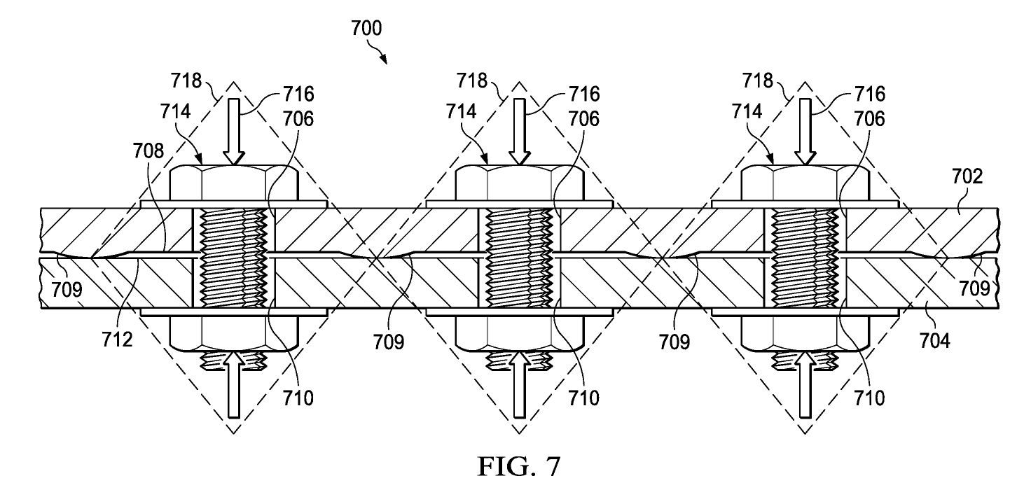

With reference now to FIG. 7, a linearized joint interface including a plurality of integral contact pads is depicted according to the first illustrative embodiment. In this illustrative example, linearized joint interface 700 includes first structure 702 and second structure 704.

First structure 702 is a structure such as first structure 202 of FIG. 2. First structure 702 includes first plurality of bolt holes 706, first contact surface 708, and plurality of integral contact pads 709. First plurality of bolt holes 706 extends through first contact surface 708. Plurality of integral contact pads 709 is integral with first contact surface 708. Plurality of integral contact pads 709 protrudes from first contact surface 708.

Second structure 704 is a structure such as structure 304 of FIG. 3. Second structure 704 includes second plurality of bolt holes 710 and second contact surface 712. Second plurality of bolt holes 710 extends through second contact surface 712. First contact surface 708 and second contact surface 712 overlap to form linearized joint interface 700.

Respective ones of plurality of bolts 714 are positioned through respective ones of first plurality of bolt holes 706 and second plurality of bolt holes 710. Applied load 716 is applied at plurality of bolts 714 to compress linearized joint interface 700. In linearized joint interface 700, contact between first contact surface 708 and second contact surface 712 is effectively limited to plurality of integral contact pads 709.

In this illustrative example, each of plurality of integral contact pads 709 is sequentially arranged with first plurality of bolt holes 706. Contact between first contact surface 708 and second contact surface 712 at plurality of integral contact pads 709 does not necessarily occur under the applied load 716 within pressure cones 718 of plurality of bolts 714.

Referring now to FIG. 8, a flowchart of a process for joining structures along a linearized joint interface is depicted according to an illustrative embodiment. Process 800 is a process for joining two structures, such as first structure 202 and second structure 204 of FIG. 2, or first structure 202 and second structure 204 of FIG. 3, to form a linearized joint interface, such as linearized joint interface 200 of FIG. 2 or linearized joint interface 300 of FIG. 3.

Process 800 begins by providing a first structure (step 810). The first structure has a first bolt hole extending through a first contact surface. The first contact surface comprises at least one integral contact pad protruding from the first contact surface.

Next, process 800 provides a second structure (step 820). The second structure has a second bolt hole extending through a second contact surface. The first contact surface and the second contact surface overlap to form the linearized joint interface.

Process 800 continues by positioning a bolt through the first bolt hole and the second bolt hole (step 830). Process 800 then applies a load at the bolt to compress the linearized joint interface (step 840). Contact between the first contact surface and the second contact surface is effectively limited to the contact pad.

The flowcharts and block diagrams in the different depicted embodiments illustrate the architecture, functionality, and operation of some possible implementations of apparatuses and methods in an illustrative embodiment. In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

### EXAMPLES

To assess the dynamics of the different beams system, assembled beam configurations were suspended so as to approximate a free-free boundary condition. In these examples, assembled beam configurations were suspended so as to minimize the amount of added stiffness and damping around the beam itself, and to reduce the prominence of sway modes that are close to zero Hertz. Sway modes are manifested as low frequency rigid body motions of the assembled beams.

### Example 1

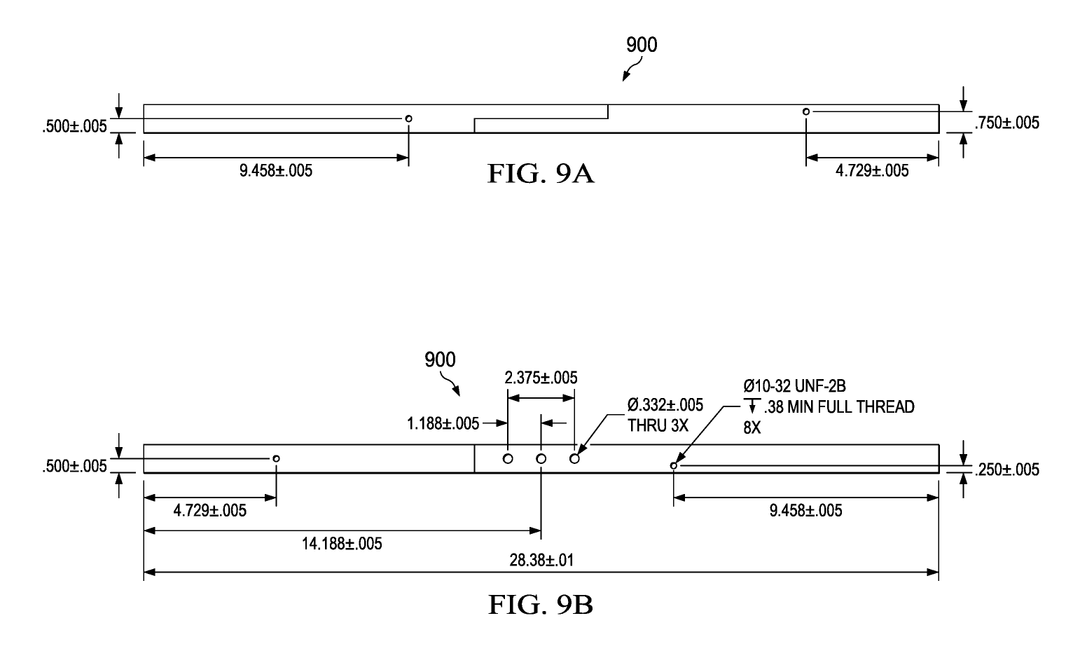

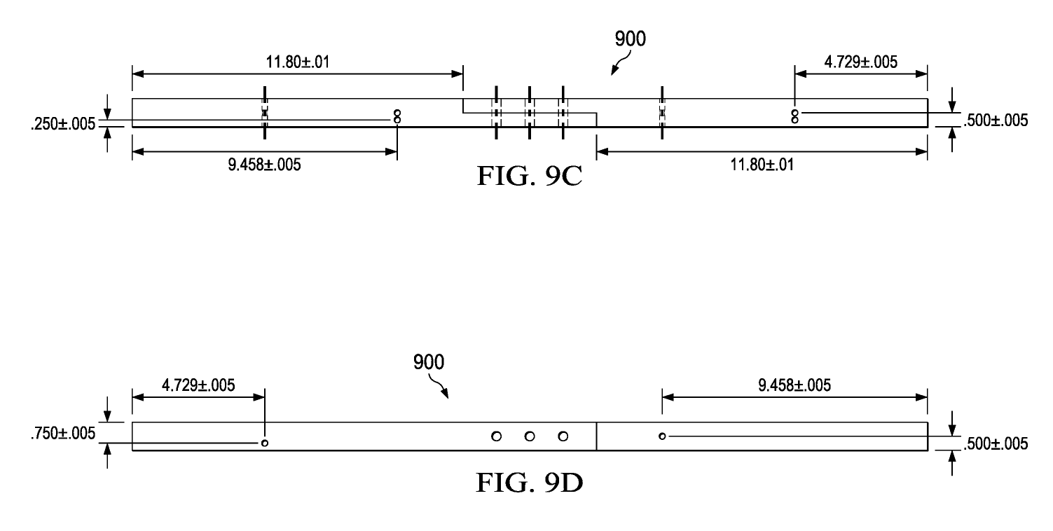

Referring now to FIGS. 9A-9D, schematics for a baseline joint interface configuration are depicted according to illustrative embodiments. As depicted, baseline joint interface configuration 900 features a lap joint held together by three bolts. As depicted, baseline joint interface configuration 900 is a flat interface characterized as a complete contact, such as joint interface 100 of FIG. 1.

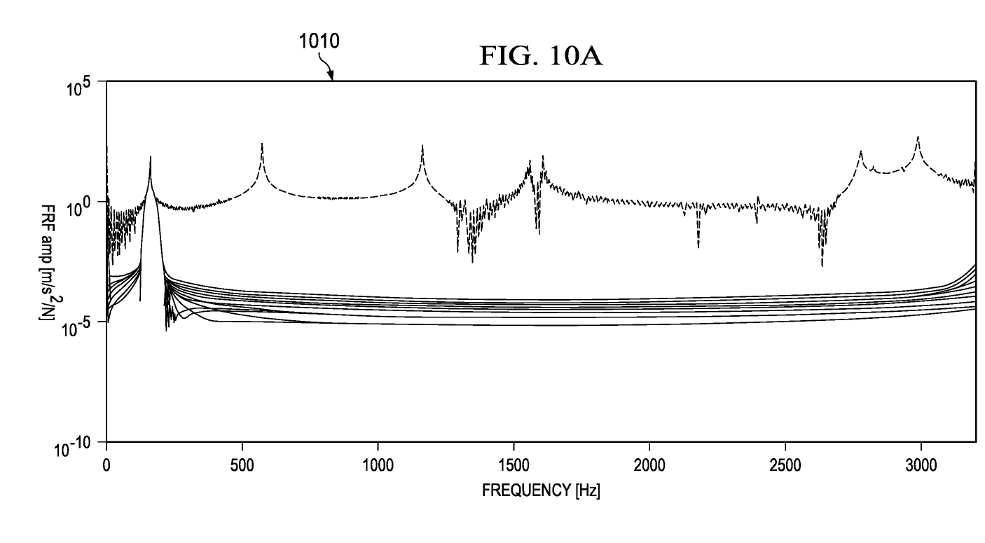

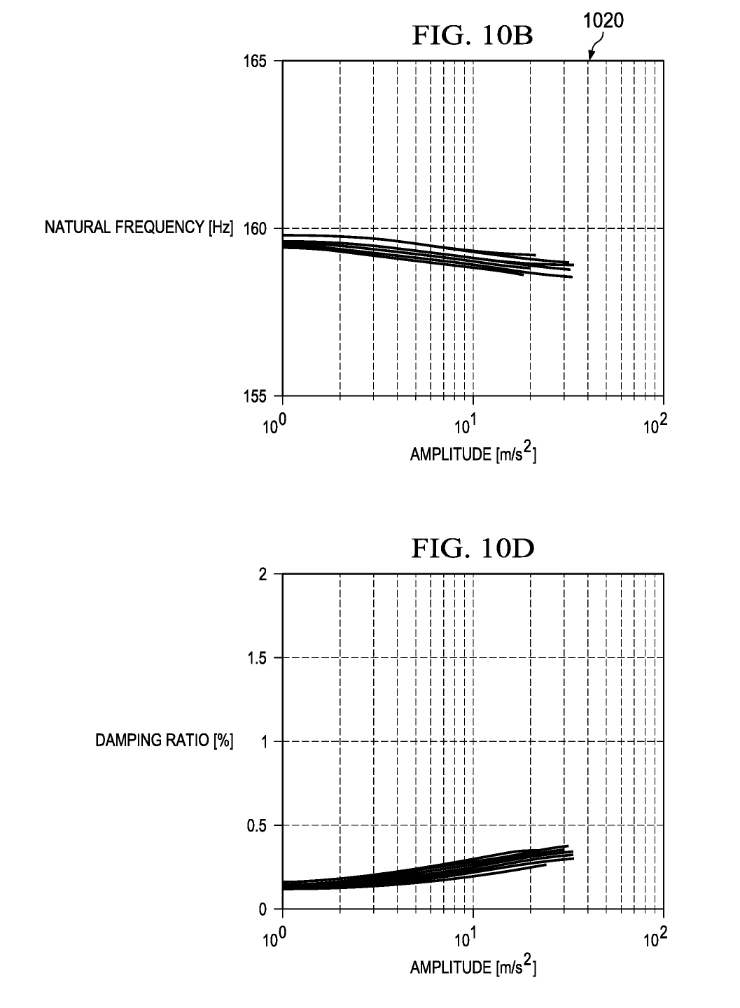

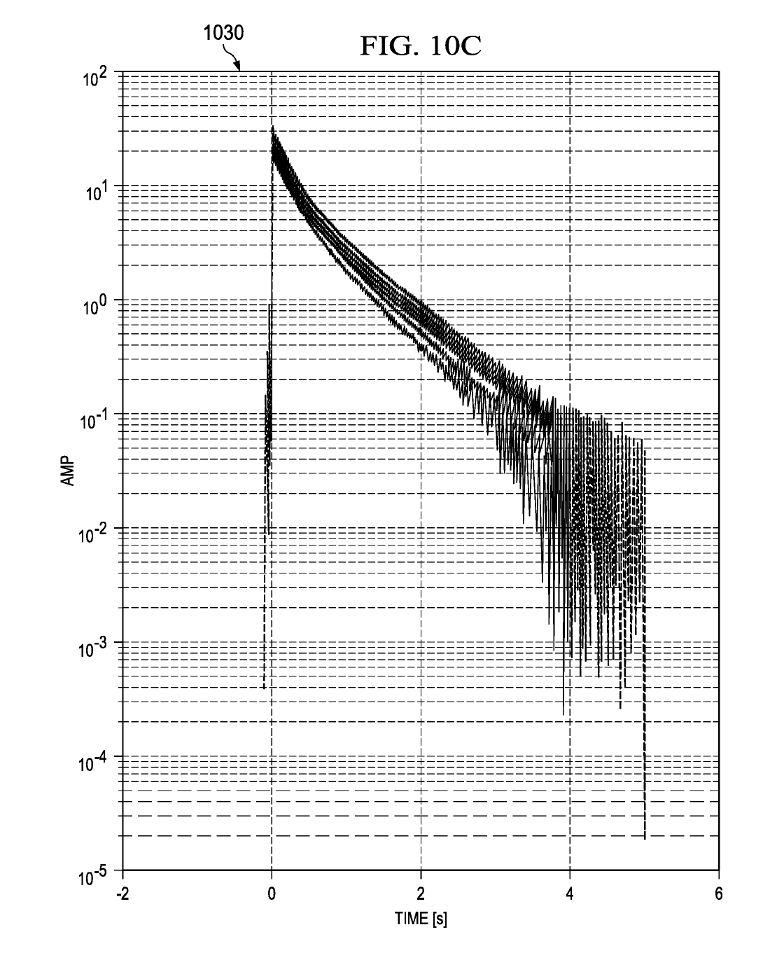

Referring now to FIGS. 10A-10D, dynamic responses of baseline joint interface configuration 900 of FIGS. 9A-9D are shown. The fast Fourier transform (FFT) of the dynamic response of baseline joint interface configuration 900 from a series of impact hammer tests is shown at 1010. The tests were modally filtered to isolate the response of the first mode, and the response for each test is shown. Multiple impacts are recorded and shown for each of the excitation levels, as is indicated by the multiple curves.

The amplitude dependent damping and frequency of baseline joint interface configuration 900 are shown at 1020. Deviations from straight, horizontal lines indicate non-linearity of baseline joint interface configuration 900. This non-linearity is indicative of a natural frequency of baseline joint interface configuration 900 that is dependent upon the excitation amplitude.

The window of response 1030 of baseline joint interface configuration 900, i.e. the absolute value of the response envelope of the response, is shown from the measured time history. In this example, the response is a transient ring down. If the system was damped by pure Coulomb damping, then the windowed response would be an exponential decay in this semi-log scale until the noise threshold is reached (at approximately 2 to 5 seconds in the following sets of experiments). On the other hand, if the response is dominated by linear viscous damping, the windowed response would be best fit by a straight line in this semi-log scale.

For baseline joint interface configuration 900, response 1030 conforms to neither that of Coulomb dry friction or linear viscous damping, but rather some intermediate value. This intermediate response is typical of jointed systems. The large shift in frequency as a function of amplitude (approximately 2.5%) indicates that as baseline joint interface configuration 900 is excited, the system transitions from being stuck together to slipping, i.e. macroslip. During macroslip, the dissipation is observed to increase dramatically.

### Example 2

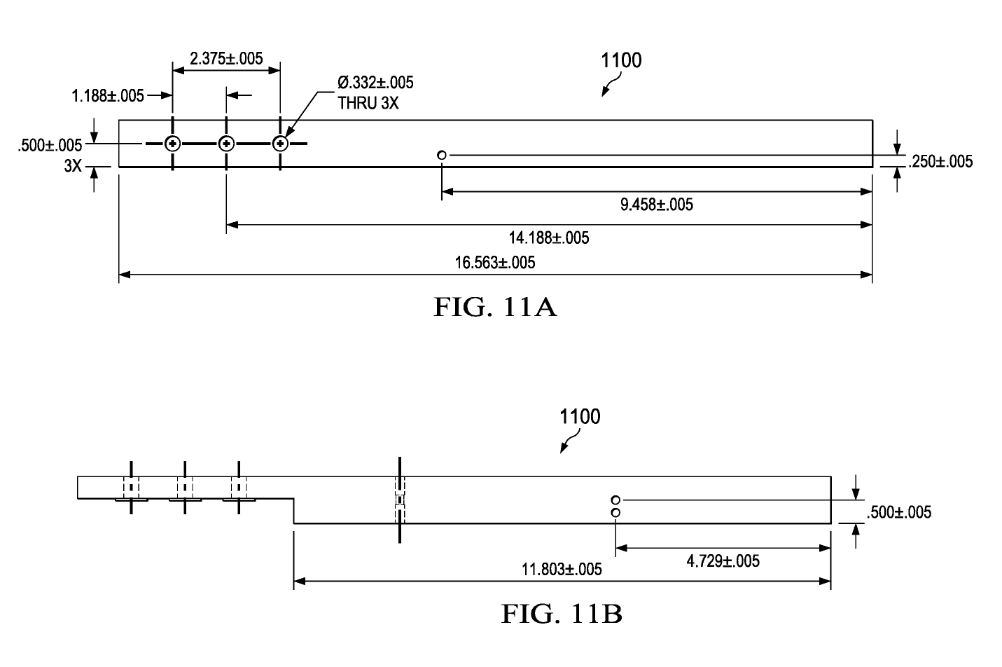

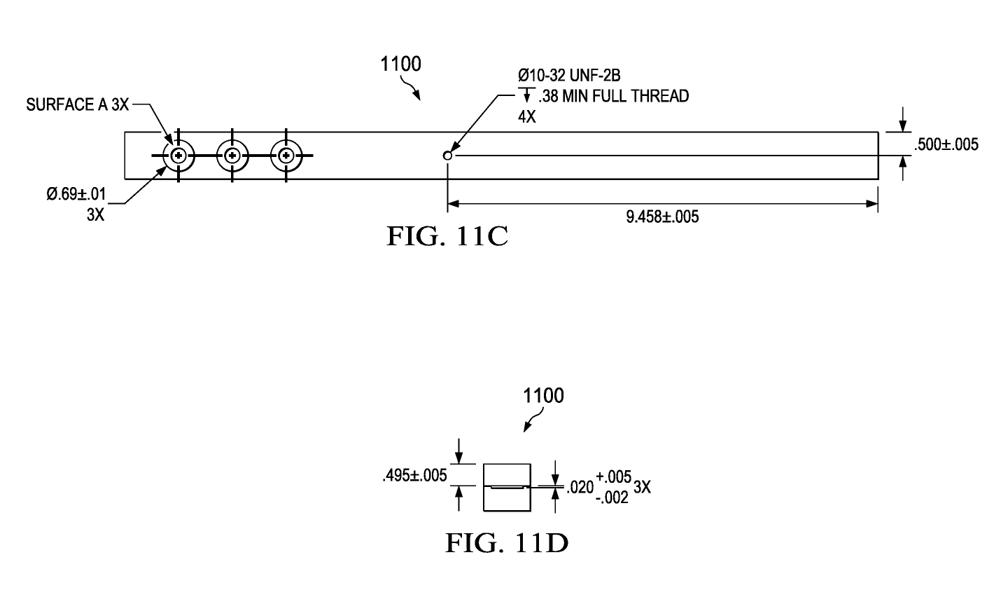

Referring now to FIGS. 11A-11D, schematics for a linearized joint interface configuration are depicted according to illustrative embodiments. As depicted, linearized joint interface configuration 1100 features a lap joint held together by three bolts. As depicted, linearized joint interface configuration 1100 is characterized as incomplete contact, such as linearized joint interface 400 of FIG. 4.

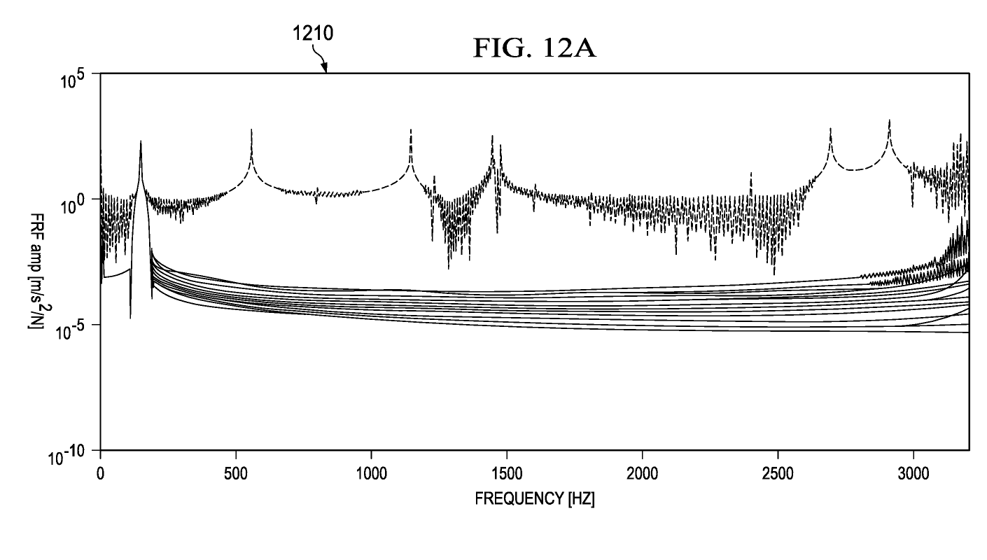

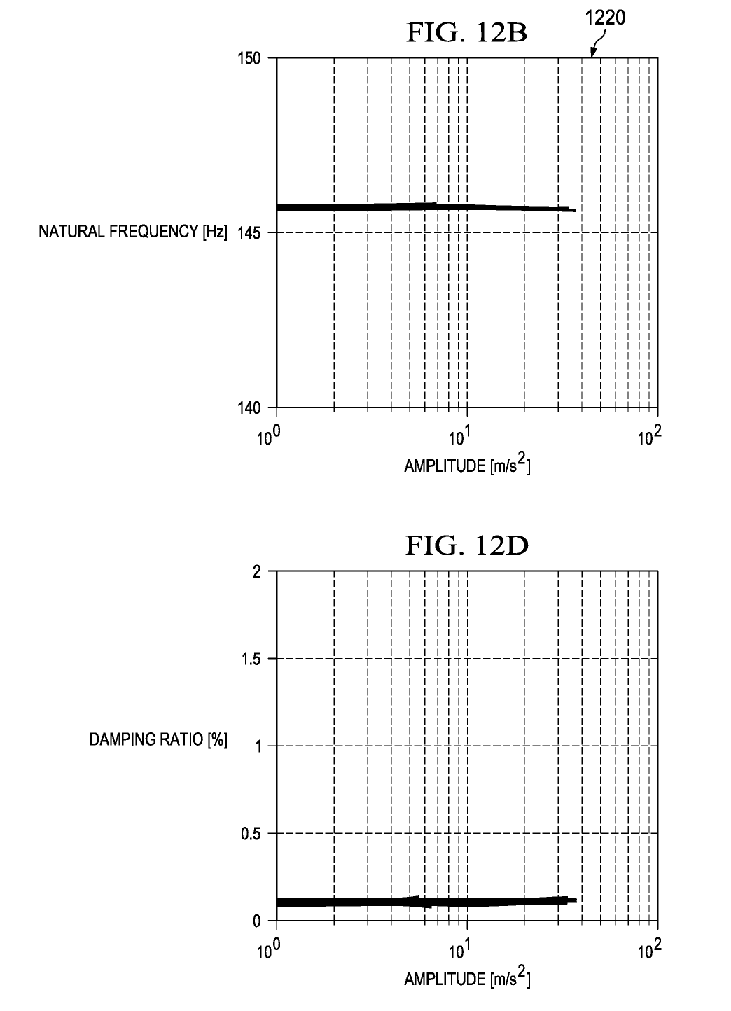

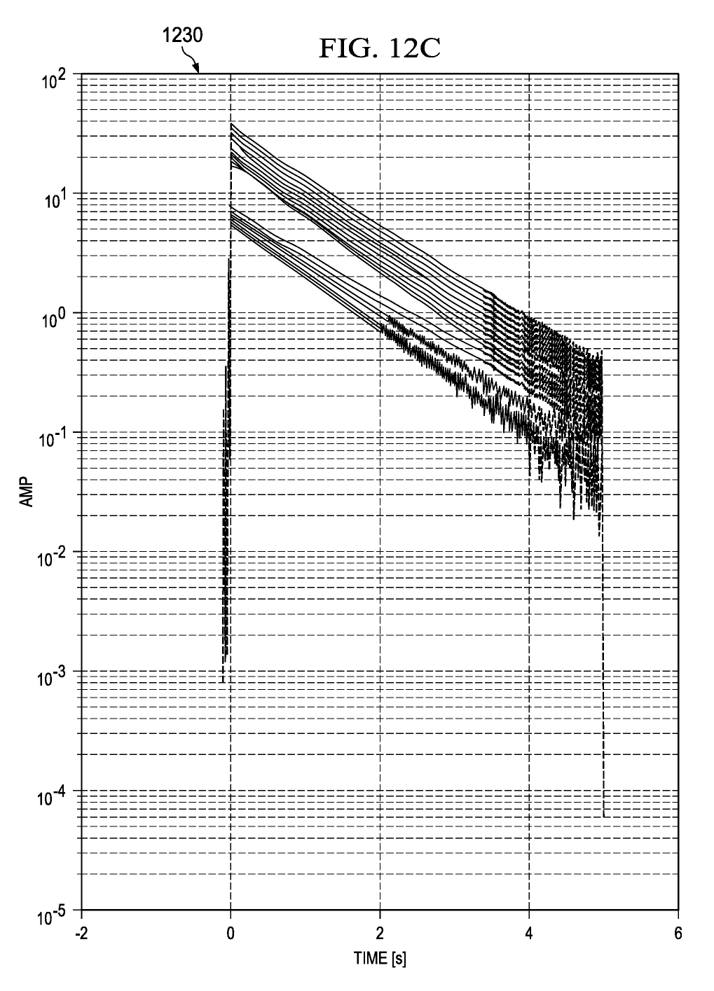

Referring now to FIGS. 12A-12D, dynamic responses of linearized joint interface configuration 1100 of FIGS. 11A-11D are shown. The fast Fourier transform (FFT) of the dynamic response of linearized joint interface configuration 1100 from a series of impact hammer tests is shown at 1210. The tests were modally filtered to isolate the response of the first mode, and the response for each test is shown. Multiple impacts are recorded and shown for each of the excitation levels, as is indicated by the multiple curves.

The amplitude dependent damping and frequency of linearized joint interface configuration 1100 are shown at 1220. The straight, horizontal lines indicate linearity of linearized joint interface configuration 1100. This linearity is indicative of a natural frequency of linearized joint interface configuration 1100 that is independent of the excitation amplitude. In contrast to baseline joint interface configuration 900, the response of linearized joint interface configuration 1100 is, for the most part, a straight line, indicating that linearized joint interface configuration 1100 could be modeled using linear viscous damping.

The window of response 1230 of linearized joint interface configuration 1100, i.e. the absolute value of the response envelope of the response, is shown from the measured time history. In contrast to baseline joint interface configuration 900, the natural frequencies of linearized joint interface configuration 1100 are approximately constant, changing by less than 0.05%. The damping ratios of linearized joint interface configuration 1100 are also approximately constant, varying between 0.07% and 0.13%, close to the material damping level of approximately 0.05% to 0.1%.

Thus, the illustrative embodiments provide a method for joining two or more joined parts and a linearized joint interface having dynamic properties that are independent of response amplitude. In one illustrative example, a linearized joint interface comprises a first structure having a first bolt hole extending through a first contact surface. The first contact surface comprises at least one integral contact pad protruding from the first contact surface. The linearized joint interface further comprises second structure having a second bolt hole extending through a second contact surface. The first contact surface and the second contact surface overlap to form the linearized joint interface. A bolt is positioned through the first bolt hole and the second bolt hole. An applied load is applied at the bolt to compress the linearized joint interface. Contact between the first contact surface and the second contact surface is effectively limited to the contact pad.

Dynamic properties of jointed systems that include the linearized joint interface are more linear than jointed systems that do not include the linearized joint interface. Dynamic properties of jointed systems that include the linearized joint interface are independent of response amplitude and more predictable than jointed systems that do not include the linearized joint interface. Correspondingly, the linearized joint interface provides dynamic properties that are more repeatable and more predictable compared to previously known joint interfaces.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A linearized joint interface comprising:
a first structure having a first bolt hole extending through a first contact surface, wherein the first contact surface comprises at least one integral contact pad protruding from the first contact surface;
a second structure having a second bolt hole extending through a second contact surface, wherein the first contact surface and the second contact surface overlap to form the linearized joint interface;
a bolt positioned through the first bolt hole and the second bolt hole, wherein an applied load is applied at the bolt to compress the linearized joint interface; and
wherein contact between the first contact surface and the second contact surface is effectively limited to a contact pad.

2. The linearized joint interface of claim 1, wherein the at least one integral contact pad is circumferentially arranged around the first bolt hole.

3. The linearized joint interface of claim 2, wherein:
the first bolt hole is one of a first plurality of bolt holes extending through the first contact surface of the first structure;
the at least one integral contact pad is one of a plurality of integral contact pads protruding from the first contact surface, wherein each of the plurality of integral contact pads is circumferentially arranged around a corresponding one of the first plurality of bolt holes;
the second bolt hole is one of a second plurality of bolt holes extending through the second contact surface of the second structure;
the bolt is one of a plurality of bolts, wherein each of the plurality of bolts is positioned through a corresponding one of the first plurality of bolt holes and the second plurality of bolt holes; and
wherein contact between the first contact surface and the second contact surface is effectively limited to a plurality of contact pads.

4. The linearized joint interface of claim 2, further comprising:
at least one of a bolt head having a bolt head radius, a first washer positioned between the bolt head and the first structure and having a first washer radius, a nut having a nut radius, and a second washer positioned between a nut and the second structure and having a second washer radius; and
wherein a pad radius of the at least one integral contact pad is less than at least one of the bolt head radius, the first washer radius, the nut radius, and the second washer radius.

5. The linearized joint interface of claim 4, wherein contact between the first contact surface and the second contact surface at the integral contact pad effectively occurs only under the applied load within a pressure cone of the bolt.

6. The linearized joint interface of claim 1, wherein the at least one integral contact pad is in Hertzian contact with the second contact surface.

7. The linearized joint interface of claim 6, wherein:
the first bolt hole is one of a first plurality of bolt holes extending through the first contact surface of the first structure;
the at least one integral contact pad is one of a plurality of integral contact pads protruding from the first contact surface, wherein the plurality of integral contact pads are sequentially arranged with the first plurality of bolt holes;
the second bolt hole is one of a second plurality of bolt holes extending through the second contact surface of the second structure;
the bolt is one of a plurality of bolts, wherein each of the plurality of bolts is positioned through a corresponding one of the first plurality of bolt holes and the second plurality of bolt holes; and
wherein contact between the first contact surface and the second contact surface is effectively limited to the Hertzian contact of the plurality of integral contact pads with the second contact surface.

8. The linearized joint interface of claim 6, further comprising:
at least one of a bolt head having a bolt head radius, a first washer positioned between the bolt head and the first structure and having a first washer radius, a nut head having a nut radius, and a second washer positioned between a nut and the second structure and having a second washer radius.

9. The linearized joint interface of claim 8, wherein contact between the first contact surface and the second contact surface at the integral contact pad does not effectively occur under the applied load within a pressure cone of the bolt.

10. A method of joining structures along a linearized joint interface, the method comprising:
providing a first structure having a first bolt hole extending through a first contact surface, wherein the first contact surface comprises at least one integral contact pad protruding from the first contact surface;
providing a second structure having a second bolt hole extending through a second contact surface, wherein the first contact surface and the second contact surface overlap to form the linearized joint interface;
positioning a bolt through the first bolt hole and the second bolt hole; and
applying a load at the bolt to compress the linearized joint interface, wherein contact between the first contact surface and the second contact surface is effectively limited to a contact pad.

11. The method of claim 10, wherein the at least one integral contact pad is circumferentially arranged around the first bolt hole.

12. The method of claim 11, wherein:
the first bolt hole is one of a first plurality of bolt holes extending through the first contact surface of the first structure;
the at least one integral contact pad is one of a plurality of integral contact pads protruding from the first contact surface, wherein each of the plurality of integral contact pads is circumferentially arranged around a corresponding one of the first plurality of bolt holes;
the second bolt hole is one of a second plurality of bolt holes extending through the second contact surface of the second structure;
the bolt is one of a plurality of bolts, wherein each of the plurality of bolts is positioned through a corresponding one of the first plurality of bolt holes and the second plurality of bolt holes; and
wherein contact between the first contact surface and the second contact surface is effectively limited to the plurality of integral contact pads.

13. The method of claim 11, further comprising:
providing at least one of a bolt head having a bolt head radius, a first washer positioned between the bolt head and the first structure and having a first washer radius, a nut head having a nut radius, and a second washer positioned between a nut and the second structure and having a second washer radius; and
wherein a pad radius of the at least one integral contact pad is less than at least one of the bolt head radius, the first washer radius, the nut radius, and the second washer radius.

14. The method of claim 13, wherein contact between the first contact surface and the second contact surface at the integral contact pad effectively occurs only under an applied load within a pressure cone of the bolt.

15. The method of claim 10, wherein the at least one integral contact pad is in Hertzian contact with the second contact surface.

16. The method of claim 15, wherein:
the first bolt hole is one of a first plurality of bolt holes extending through the first contact surface of the first structure;
the at least one integral contact pad is one of a plurality of integral contact pads protruding from the first contact surface, wherein the plurality of integral contact pads are sequentially arranged with the first plurality of bolt holes;
the second bolt hole is one of a second plurality of bolt holes extending through the second contact surface of the second structure;
the bolt is one of a plurality of bolts, wherein each of the plurality of bolts is positioned through a corresponding one of the first plurality of bolt holes and the second plurality of bolt holes; and
wherein contact between the first contact surface and the second contact surface is effectively limited to the Hertzian contact of the plurality of integral contact pads with the second contact surface.

17. The method of claim 16, further comprising:
providing at least one of a bolt head having a bolt head radius, a first washer positioned between the bolt head and the first structure and having a first washer radius, a nut head having a nut radius, and a second washer positioned between a nut and the second structure and having a second washer radius.

18. The method of claim 17, wherein contact between the first contact surface and the second contact surface at the integral contact pad does not effectively occur under an applied load within a pressure cone of the bolt.
